(19) United States
(12) Patent Application Publication
(10) Pub. No.: US 2026/0307764 A1
(43) Pub. Date: Oct. 8, 2026

(54) Surf Craft

(71) Applicant: Macquarie University, New South Wales (AU)

(72) Inventors: Nathan Hart, New South Wales (AU); Laura Ryan, New South Wales (AU)

(21) Appl. No.: 19/483,898

(22) PCT Filed: May 17, 2024
(86) PCT No.: PCT/AU2024/050500

§ 371 Date: Nov. 12, 2025

(30) Foreign Application Priority Data
May 18, 2023 (AU) 2023901539

(51) Int. Cl. B63B 32/70; B63B 45/02; B63C 9/00

(52) U.S. Cl. CPC B63B 32/70; B63B 45/02; B63C 9/00; B63C 2009/0088

(57) ABSTRACT

The present disclosure relates to a surf craft comprising one or more illuminated regions on an underside of the surf craft, the underside defining a surface that faces a body of water in use. The disclosure also relates to a method of reducing interactions with sharks, the method comprising arranging one or more illuminated portions on an underside of a surf craft, the underside defining a surface that faces a body of water in use, and a system for reducing interaction of sharks with a surf craft, the system comprising arranging one or more lights on at least a portion of downward facing surfaces of the surf craft, the one or lights being arranged such that the surf craft is counter-illuminated.

### TECHNICAL FIELD

This disclosure relates generally to a system for reducing interactions between ocean predators and surf craft, and in particular to reducing interaction between white sharks and a surf craft floating at the ocean surface.

### BACKGROUND

Although sharks interpret their world using a range of sensory modalities, there is evidence that many species, including white sharks, use vision to identify and target potential prey. For example, white sharks bite stationary non-prey items floating on the surface, which emit few sensory cues other than the visual cue of the silhouette. Many species of shark possess visual adaptations that will aid in the identification of objects silhouetted against the sky at the surface. For example, sharks have high contrast sensitivity compared to other marine species, which would assist in the discrimination of an object against its background.

Studies support a mistaken identity theory behind some white shark bites on humans, in which the visual similarities between the silhouette of humans and natural pinniped prey may lead to predatory encounters. Given the importance of the visual sense in white shark predation, at least at close range, there have been several attempts to develop vision-based shark deterrent devices.

The ‘Johnson Shark Screen’, was a large impermeable bag that a person adrift in the ocean would fill with water before entering, it restricted the release of odours, bio-electrical emissions and water displacements that might attract sharks, as well as visually concealing the occupant. Importantly, the colour of the bag had a significant influence on its effectiveness. White and silver bags, which have a higher reflectivity, were more attractive than blue or black bags with low reflectivity, thus lower visual contrast when viewed in the water column. Camouflage wetsuits have also been designed by estimating the reflectance spectra that provide minimal visual contrast against the water background when viewed by a shark. However, both the shark screen and wetsuit suffer from the problem that, regardless of spectral reflectance, they remain visible as a dark silhouette when viewed from below by predators such as white sharks.

There remains a need for an improved shark mitigation strategy for surf craft and those operating the surf craft.

### SUMMARY OF THE DISCLOSURE

In a first aspect, embodiments are disclosed of a surf craft comprising one or more illuminated regions on an underside of the surf craft, the underside defining a surface that faces a body of water in use.

In some embodiments, the one or more illuminated regions may cover between 5% and 50% of the underside of the surf craft. In some embodiments, the one or more illuminated regions may cover more than 50% of the underside of the surf craft.

In some embodiments, the one or more illuminated regions may be arranged to form at least one stripe that extends at least partially across a width and/or length of the surf craft. In some embodiments, the at least one stripe may extend substantially linearly. In some embodiments, the surf craft may comprise a plurality of the at least one stripe, the plurality of stripes being arranged to extend at spaced intervals across the surf craft. In some embodiments, the intervals may be evenly distributed across the surf craft, such that a distance between adjacent stripes of the plurality of stripes is equidistant. In some embodiments, the at least one stripe may be oriented perpendicular to a long axis of the surf craft and/or a direction of travel of the surf craft. In some embodiments, a width of the at least one stripe may be equal to, or more than, 2 cm. In some embodiments, a width of the at least one stripe may be equal to, or more than, 4 cm. In some embodiments, the distance between the adjacent stripes may be equal to, or less than, 30 cm.

In some embodiments, a contrast of the one or more illuminated portions and a portion of the underside of the surf craft without the one or more illuminated portions may be equal to, or greater than, 85% Michelson contrast. In some embodiments, the one or more illuminated portions may be configured to provide illumination continuously. In some embodiments, the one or more illuminated portions may provide white light.

In some embodiments, the one or more illuminated portions may comprise a shield that is configured to reduce and/or block electrical fields emanating away from the surf craft.

In some embodiments, the one or more illuminated portions may comprise one or more lights. In some embodiments, the one or more lights may be LED lights. In some embodiments, the one or more lights may be fixedly secured to the underside of the surf craft. In some embodiments, the one or more lights may be at least partially embedded within the underside of the surf craft. In some embodiments, the one or more illuminated portions may be powered by a rechargeable battery.

In some embodiments, when viewed in plan, the profile of the surf craft may be substantially ovular. In some embodiments, when viewed in plan, the profile of the surf craft may correspond to a profile of an animal. In some embodiments, the surf craft may be a surf board.

In some embodiments, the one or more illuminated portions may substantially mimic or exceed the brightness at a wavelength or a combination of wavelengths of a downwelling light of a surrounding area of ocean. In some embodiments, the one or more illuminated portions may have a radiance at a wavelength or a combination of wavelengths that is brighter than 2×10⁻³ W cm⁻² sr⁻¹.

In a further aspect, embodiments are disclosed of a method of reducing interactions with sharks, the method comprising arranging one or more illuminated portions on an underside of a surf craft, the underside defining a surface that faces a body of water in use.

In some embodiments, the one or more illuminated portions may be configured to provide illumination continuously.

In some embodiments, the one or more illuminated portions may be arranged to form at least one substantially linear stripe that extends at least partially across the surf craft perpendicular to a long axis of the surf craft and/or a direction of travel of the surf craft.

In some embodiments, the method may further comprise moving the surf craft in the direction of travel across a surface of the body of water. In some embodiments, the method may further comprise allowing the surf craft to remain substantially stationary at a surface of the body of water.

In a further aspect, embodiments are disclosed of a system for reducing interaction of sharks with a surf craft, the system comprising arranging one or more lights on at least a portion of downward facing surfaces of the surf craft, the one or lights being arranged such that the surf craft is counter-illuminated.

Other aspects, features, and advantages will become apparent from the following detailed description when taken in conjunction with the accompanying drawings, which are a part of this disclosure and which illustrate, by way of example, principles of inventions disclosed.

### DESCRIPTION OF THE FIGURES

The accompanying drawings facilitate an understanding of the various embodiments. The invention will now be described, by way of non-limiting example only, with reference to the accompanying drawings, in which:

FIGS. 1A to 1C are a plan view, from below, of a first embodiment of a surf craft having an underside covered entirely by a plurality of lights, the plurality of lights radiating at dim, moderate and bright brightness levels, respectively.

FIG. 2 is a plan view, from below, of a second embodiment of a surf craft having a plurality of groups of stripes of lights arranged substantially perpendicularly to the long axis of the surf craft across the underside of the surf craft.

FIG. 3 is a plan view, from below, of a third embodiment of a surf craft having a plurality of groups of stripes of lights arranged substantially perpendicularly to the long axis of the surf craft across the underside of the surf craft.

FIG. 4 is a plan view, from below, of a fourth embodiment of a surf craft having a plurality of groups of stripes of lights arranged substantially perpendicularly to the long axis of the surf craft across the underside of the surf craft.

FIG. 5 is a plan view, from below, of a fifth embodiment of a surf craft having a plurality of groups of stripes of lights arranged substantially perpendicularly to the long axis of the surf craft across the underside of the surf craft.

FIG. 6 is a plan view, from below, of a sixth embodiment of a surf craft having a plurality of groups of stripes of lights arranged substantially parallel to the long axis of the surf craft across the underside of the surf craft.

### DETAILED DESCRIPTION

Referring to the Figures, a surf craft 100 is disclosed that is configured for reducing the instances of interaction between white sharks and the surf craft 100. Where like reference numerals are used in the following description, the features are considered to be the same unless specified as being otherwise.

One or more illuminated portions, for example lights 10, are arranged on at least a portion of the underside 52 of the surf craft 100, with the illuminated portions arranged in a manner such that the surf craft 100 is effectively counter-illuminated. Where reference is made to the underside 52 of the surf craft 100, this means the surface of the surf craft 100 that in use would face the body of water (e.g. the ocean, lake or river). The counter-illumination of the surf craft 100 substantially mimics, or exceeds, the brightness at relevant wavelengths or combinations of wavelengths of the down-welling light of a surrounding area of the body of water 90 thereby reducing the visibility and contrast or otherwise altering the perceptual salience of the silhouette of the surf craft 100 against the adjacent body of water 90 background when viewed from below by upward-looking predators, such as sharks. The one or more illuminated portions effectively provide an active camouflage to the surf craft 100 by allowing the surf craft 100 to more effectively replicate and resemble its surrounding background in both brightness and wavelength.

Counter-illumination may be a particularly successful camouflage strategy against predators, such as white sharks, that have visual systems with low spatial resolution and poor or no colour discrimination ability. By providing the system 100 on the downward facing underside 52 of a surface-floating surf craft 100, prey capture-like behavioural interactions by white sharks can be reduced and/or prevented. These behaviours may include a ‘breach’, where a significant portion of the body of the shark leaves the water and/or the shark attempts to bite and/or hit the surf craft; or a ‘follow’, where the shark surfaces from the ocean such that its dorsal fin is visible and swims closely (e.g. <10 m estimated by eye) behind the surf craft in a highly directional manner for at least several seconds.

In some variations where the background against which the silhouette of the surf craft 100 is viewed is relatively dark (e.g. the sky is overcast, or at dawn or dusk) the surf craft 100 may present a bright silhouette relative to the surrounding area of the body of water 90. In such variations, the counter-illumination of the surf craft 100 may effectively reduce and/or prevent prey capture-like behavioural interactions by white sharks. This may be a result of one or more of neophobia and/or the lack of resemblance of the surf craft 100 with typical visual cues provided by common prey of white sharks.

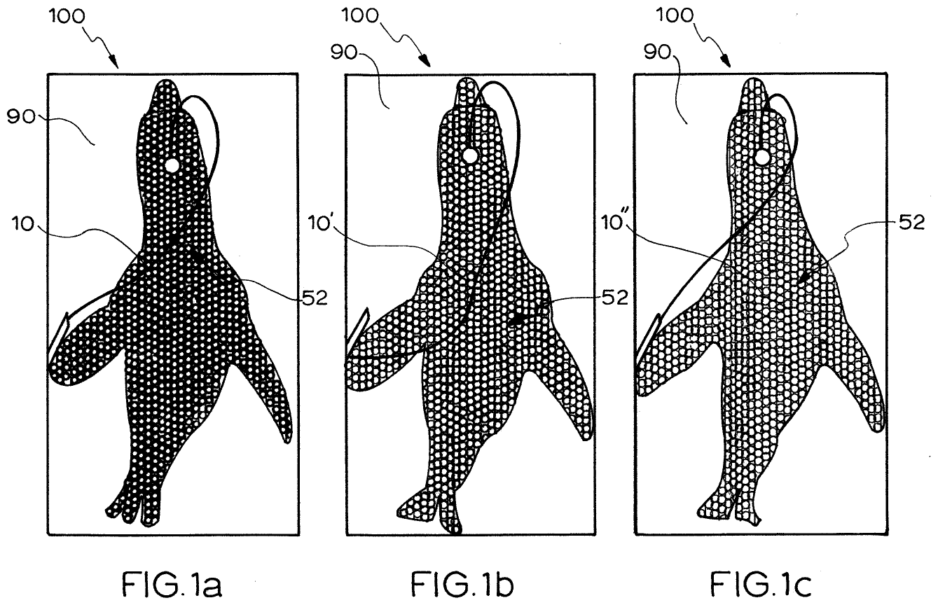

The surf craft 100 can be formed to have a substantially ovular profile. As would be understood by a person skilled in the art, the surf craft 100 can be formed to have a wide variety of lengths, widths and end shapes provided that it is adapted to float at the surface of the body of water 90 (e.g. ocean). Examples of surf craft may include, but are not limited to, a surf board, stand-up paddle board, longboard, gun, midsize, hybrid, shortboard, fish, tow-in, bodyboard, surf ski, stand-up paddle board etc. Where reference is made to a substantially ovular shape, this refers to the overall shape having resemblance to an elongate oval when viewed in plan from below, and may also include surf craft having leading or tail shapes that are round, diamond, square, squash, pin or fish etc. With reference to FIGS. 1 to 6, the surf craft 100 can be formed to have a profile, when viewed in plan from below, that resembles the silhouette of an animal, such as a seal. The surf craft 100 can float in a substantially stationary position at the surface of the body of water 90, or can be moving, in use. For example, the surf craft 100 can be comprise a tow strap 80 to enable the surf craft to be towed by another surf craft or vehicle. Alternatively, the surf craft 100 can be powered to move by a sail, by paddle/s or by a swimmer.

The illuminated portions preferably emit light at a radiance, at relevant wavelengths or combinations of wavelengths, that is brighter than 2×10⁻³ W cm⁻² sr⁻¹. The portion of the underside 52 of the surf craft 100 that is brightened by the illuminated portion/s preferably has a contrast that is equal to, or greater than, 85% Michelson contrast when compared with the non-illuminated portion/s of the underside 52 of the surf craft 100. The light sources (e.g. LED chips) may be distributed uniformly within the illuminated portions, and may preferably be at a density of between 60 and 240 chips per linear metre, depending on LED chip specifications and other factors that may affect the emitted light intensity from each chip. White light may be preferable in order to maximise the brightness of the illuminated portions. For example, the illuminated portions can be one or more lights 10 (e.g. LED lights). As would be understood by a person skilled in the art, other types of light sources and colours of light may be used provided that the illuminated portions provide the preferred radiance and contrast, noting that most sharks appear to have maximum visual sensitivity in the green (~500-530 nm) region of the visible spectrum. The illuminated portions preferably emit light in a constant and continuous manner, although in some variations the illuminated portions can be configured to emit light in a non-continuous manner (e.g. flash or strobe on and off in a patterned or random sequence).

The one or more illuminated portions can be arranged to cover greater than 50%, or to completely cover, the underside 52 of the surf craft 100. A similar level of efficacy in the reduction in interactions (breaches and follows) between white sharks and the counter-illuminated system 100 can be achieved by arranging the one or more lights 10 to cover only a portion of the underside 52 of the surf craft 100. For example, between 5% and 50% of the underside 52 of the surf craft 100.

The one or more illuminated portions can be arranged in high contrast patterns, such as stripes 20 that extend laterally across or longitudinally along the underside 52 of the surf craft 100. The stripes 20 can be formed by a plurality of illuminated portions (e.g. multiple lights 10 arranged in a line) or by a single illuminated portion that is arranged to extend for the length of the stripe 20. The stripes 20 can be arranged to extend at least partially across a width and/or length and/or diagonal of the surf craft 100, or in some forms, across the full length and/or width and/or diagonal of the surf craft 100, or in some forms, as a repeated pattern of illuminated 12 and non-illuminated 14 portions that extend across the surf craft 100 (e.g. see FIG. 4). As would be understood by a person skilled in the art, the stripes 20 can be arranged to extend linearly, or to follow curved, wavy, circular, square or other shaped paths across the underside of the surf craft 100.

The one or more lights 10 of the illuminated portion and/or the stripes 20 comprising the one or more lights 10 can be removably secured to the underside 52 of the surf craft 100. In a variation, the one or more lights 10 and/or the stripes 20 can be fixedly secured to the outer surface of the surf craft 100 or at least partially embedded within the underside 52 of the surf craft 100. The illuminated portions can be powered to operate by a rechargeable battery that is removably contained in a waterproof compartment on the surf craft 100. The circuitry of the illuminated portions can be covered by a shield that is configured to reduce and/or block electrical fields emanating away from the surf craft 100.

In forms having a plurality of stripes 20, an adjacent two of the stripes 20 can be arranged at spaced intervals 24 across the surf craft 100, for example to provide an even distribution of light across the underside 52 of the surf craft 100. The spacing of the intervals between adjacent stripes 20 can be equidistant such that each stripe 20 is evenly spaced from an adjacent stripe 20, or in a variation, the spacing of the intervals can follow an irregular and uneven sequence. In some forms, the spacing of the intervals between adjacent stripes 20 can define a repeating pattern. For example, with reference to FIG. 3, the stripes 20 are arranged in groups 22 of four stripes 20, with the spacing of intervals 24 between adjacent stripes 20 within a group 22 being substantially equidistant, and the spacing of intervals 24′ between adjacent groups 22 of stripes 20 being substantially equidistant. It may be preferable in some forms to arrange the stripes 20 such that the spacing of intervals 24 between adjacent stripes 20 and/or the spacing of intervals 24′ between adjacent groups 22 of stripes 20 is equal to, or less than, 30 cm. In some further forms it may be preferable to arrange the stripes 20 such that the spacing of intervals 24 between adjacent stripes 20 and/or the spacing of intervals 24′ between adjacent groups 22 of stripes 20 is equal to, or less than, 28 cm

The length of the stripes 20 can vary across the surf craft 100. For example, with reference to FIGS. 4 & 5, the length of each of the stripes 20 can be adapted to conform variations in the width and/or length of the surf craft 100. It may be preferable in some forms to have stripes 20, or groups 22 of stripes 20, that have a cumulative width that is equal to, or more than, 2 cm. In some forms, it may be preferable to have stripes 20, or groups 22 of stripes 20, that have a cumulative width that is equal to, or more than, 4 cm. In some alternative forms, narrow stripes 20 having a width less than 2 cm may be used to emit light of sufficient brightness. In some forms, adjacent stripes 20 can be located immediately alongside one another, whereby a group 22 of the stripes 20 effectively defines a combined stripe 20 that appears to have a larger width.

The stripes 20 can be arranged to extend substantially parallel to one another. In a variation, the stripes 20 can be arranged to extend at a variety of angles between 0 and 90 degrees relative to one another. In a further variation, the stripes 20 of a single group 22 can be arranged to extend substantially parallel to one another, with adjacent groups 22 being arranged either substantially parallel, or at an angle between 0 and 90 degrees, relative to the first group 22.

Referring to FIG. 1A, a seal-shaped surf craft 100 is shown floating at the surface of the ocean 90, viewed in plan from below. The underside 52 of the surf craft 100 comprises a plurality of LED lights 10 that are arranged to cover the entirety of the underside 52. Individual LED lights 10 can be mounted to the surf craft 100 across the underside 52. Alternatively, a plurality of the LED lights 10 can be spaced along a pre-formed strip of material so as to define together a stripe 20, with a plurality of the stripes 20 arranged alongside one another across the underside 52 so as to effectively cover substantially the entirety of the underside 52 of the surf craft 100. The plurality of lights 10 are configured to provide white light at a radiance of approx. 2.5×10⁻³ W cm⁻² sr⁻¹, which defines a dim brightness level.

Referring to FIG. 1B, a similar seal-shaped surf craft 100 to FIG. 1A is shown floating at the surface of the ocean 90, viewed in plan from below. However, the plurality of LED lights 10′ are arranged to cover the entirety of the underside 52 of the surf craft 100. The plurality of lights 10′ are configured to provide white light at a radiance of approx. 3.6×10⁻³ W cm⁻² sr⁻¹, which defines a moderate brightness level.

Referring to FIG. 1C, a similar seal-shaped surf craft 100 to FIGS. 1A and 1B is shown floating at the surface of the ocean 90, viewed in plan from below. The plurality of LED lights 10″ are arranged to cover the entirety of the underside 52 and are configured to provide white light at a radiance of approx. 4.6×10⁻³ W cm⁻² sr⁻¹, which defines a bright brightness level.

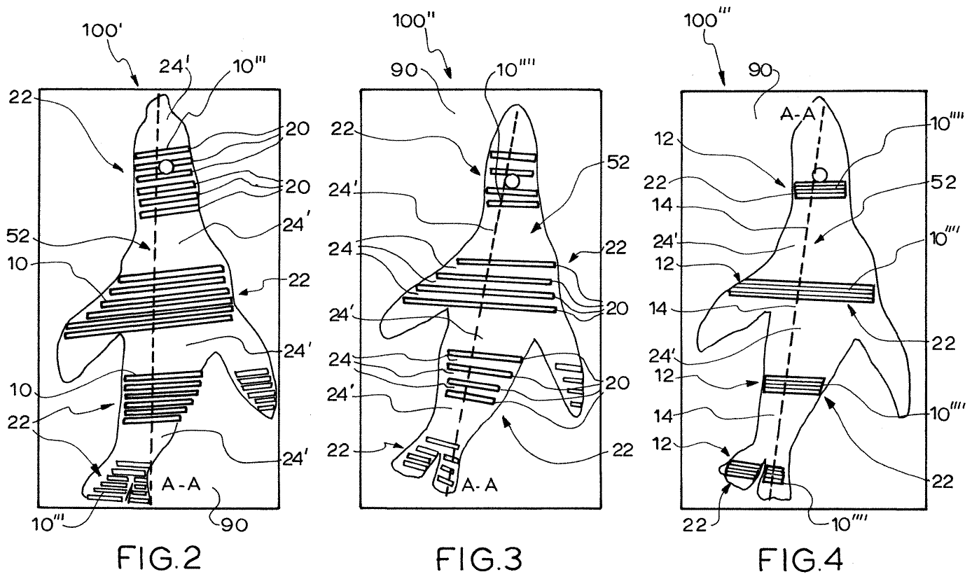

Referring to FIG. 2, a similar seal-shaped surf craft 100′ to FIGS. 1A-1C is shown floating at the surface of the ocean 90, viewed in plan from below. The plurality of LED lights 10′″ are arranged in a plurality of groups 22 of stripes 20 of lights 10′″, with each group comprising six stripes 20 of lights 10′″ that are oriented to extend perpendicularly across the surf craft 100′ relative to the long axis A-A of the surf craft 100′ and/or a direction of travel of the surf craft. The LED lights 10′″ can be individually mounted to the surf craft 100′ to form together one or more stripe 20. In some alternatives, a plurality of the LED lights 10′″ can be spaced along a pre-formed strip of material so as to define each stripe 20, with the stripe 20 comprising a plurality of the LED lights 10′″ being mountable to the surf craft 100′ as a pre-arranged unit. A perpendicular orientation of the one or more lights 10 may provide a motion dazzle camouflage effect for the surf craft 100′ to the extent that the one or more lights 10 perpendicular to the long axis A-A and/or direction of travel creates sufficient confusion and makes it difficult for the predator to track the surf craft 100′. The stripes 20 are spaced at intervals 24 of 3 cm within a group 22, with the group 22 of stripes having a cumulative width of approximately 15 cm. The spacing of the intervals 24′ between adjacent groups 22 of stripes 20 is approximately 15 cm. The length of each of the stripes 20 varies based on the width of the surf craft 100, with some stripes 20 also being interrupted by gaps in the surf craft 100, for example, where the seal shape has a limb that projects away from the seal body. The illuminated portions comprise of four groups 22 of the stripes 20 across the underside 52 of the surf craft 100′. The groups 22 are spaced at intervals 24′ along the long axis A-A of the surf craft 100′, with an additional unlit interval 24′ provided at one end of the surf craft 100′. The unlit intervals 24′ defining non-counter-illuminated portions of the underside 52. The illuminated portions and non-illuminated portions of the underside 52 are approximately equal (i.e. 50% each). The lights 10′″ have a uniform spacing of approximately 120 LEDs per linear metre across the stripes 20, and are configured to provide white light at a radiance of approx. 3.9×10⁻³ W cm⁻² sr⁻¹.

Referring to FIG. 3, a similar seal-shaped surf craft 100″ to FIG. 2 is shown floating at the surface of the ocean 90, viewed in plan from below. The illuminated portions of the surf craft 100″ utilises the same total number of LED lights 10′″ as the illuminated portions of the surf craft 100′ of FIG. 2, but at a radiance of approximately 3.2×10⁻³ W cm⁻² sr⁻¹, and arranged into groups 22 comprising four stripes 20 of lights 10″″ that are oriented to extend perpendicularly across the surf craft 100″ relative to the long axis A-A of the surf craft 100″ and/or a direction of travel of the surf craft 100″. The group 22 of stripes 20 are spaced at intervals 24 within a group 22 such that the group 22 of stripes has a cumulative width of approximately 15 cm. The spacing of the intervals 24′ between adjacent groups 22 of stripes 20 is approximately 15 cm.

Referring to FIG. 4, a similar seal-shaped surf craft 100′″ to FIG. 3 is shown floating at the surface of the ocean 90, viewed in plan from below. The illuminated portions of the surf craft 100′″ utilises 30% less LED lights 10″″ than the total number of LED lights 10″″ utilised by the illuminated portions of the surf craft 100″ of FIG. 3, with the lights 10″″ configured to provide a higher radiance than FIGS. 2 and 3, being a radiance of approx. 4.9×10⁻³ W cm⁻² sr⁻¹. The plurality of LED lights 10″″ are arranged in a plurality of groups 22 of stripes 20 of lights 10″″, with each stripe 20 of lights 10″″ being oriented to extend perpendicularly across the surf craft 100′″ relative to the long axis A-A of the surf craft 100′″ and/or a direction of travel of the surf craft 100′″. The stripes 20 are spaced directly alongside one another within a group 22 so as to effectively provide the appearance of a unitary stripe, with the group 22 of stripes 20 having a cumulative width of approximately 4 cm. The spacing of the intervals 24′ between adjacent groups 22 of stripes 20 is approximately 24 cm.

Referring to FIG. 5, a similar seal-shaped surf craft 100″″ to FIGS. 1-4 is shown floating at the surface of the ocean 90, viewed in plan from below. The illuminated portions of the surf craft 100″″ comprises four stripes 20 of the one or more lights 10″″ that are arranged to orient substantially perpendicular to a long axis A-A of the surf craft 100″″ and/or a direction of travel of the surf craft 100″″. The stripes 20 have a width of 2 cm, and are spaced from adjacent stripes 20 by an interval 24 that is 27 cm in width. The illuminated portions of the surf craft 100″″ utilises approximately 50% less total LED lights 10′″″ than the total number of LED lights 10″″ utilised by the illuminated portions of the surf craft 100′″ of FIG. 4, with the lights 10′″″ configured to provide white light at a radiance of approx. 2.5×10⁻³ W cm⁻² sr⁻¹.

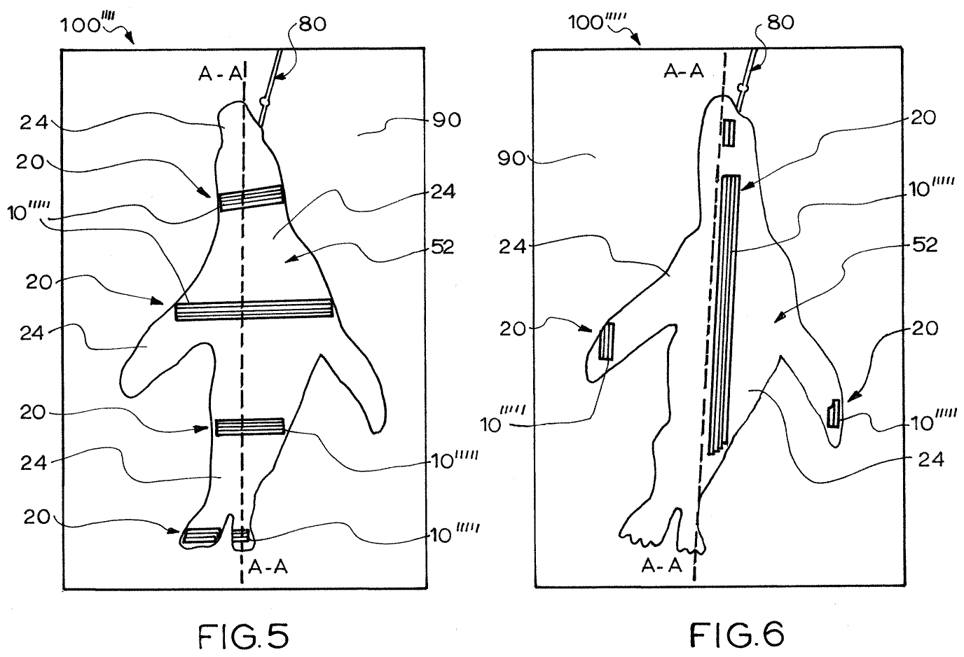

Referring to FIG. 6, a similar seal-shaped surf craft 100 to FIGS. 1-5 is shown floating at the surface of the ocean 90, viewed in plan from below. The illuminated portions of the surf craft 100′″″ comprises three stripes 20 of the one or more lights 10′″″ that are arranged to orient substantially parallel to a long axis A-A of the surf craft 100′″″ and/or a direction of travel of the surf craft 100′″″. The stripes 20 of the illuminated portions of the surf craft 100′″″ have a width of 2 cm, and are spaced from adjacent stripes 20 by an interval 24 that is 27 cm in width. The illuminated portions of the surf craft 100′″″ utilises approximately 50% less total LED lights 10′″″ than the total number of LED lights 10′″″ utilised by the illuminated portions of the surf craft 100′″″ of FIG. 5, with the lights 10′″″ configured to provide white light at a radiance of approx. 2.1×10⁻³ W cm⁻² sr⁻¹.

Variations and modifications may be made to the parts previously described without departing from the spirit or ambit of the disclosure.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1-33. (canceled)

34. A surf craft comprising one or more illuminated regions on an underside of the surf craft, the underside defining a surface that faces a body of water in use.

35. The surf craft of claim 34, wherein the one or more illuminated regions cover between 5% and 50% of the underside of the surf craft.

36. The surf craft of claim 34, wherein the one or more illuminated regions cover more than 50% of the underside of the surf craft.

37. The surf craft of claim 34, wherein the one or more illuminated regions are arranged to form at least one stripe that extends at least partially across a width and/or length of the surf craft.

38. The surf craft of claim 37, wherein the at least one stripe extends substantially linearly.

39. The surf craft of claim 37, wherein the surf craft comprises a plurality of the at least one stripe, the plurality of stripes being arranged to extend at spaced intervals across the surf craft.

40. The surf craft of claim 39, wherein the intervals are evenly distributed across the surf craft, such that a distance between adjacent stripes of the plurality of stripes is equidistant.

41. The surf craft of claim 37, wherein the at least one stripe is oriented perpendicular to a long axis of the surf craft and/or a direction of travel of the surf craft.

42. The surf craft of claim 37, wherein a width of the at least one stripe is equal to, or more than, 2 cm.

43. The surf craft of claim 40, wherein the distance between the adjacent stripes is equal to, or less than, 30 cm.

44. The surf craft of claim 34, wherein a contrast of the one or more illuminated portions and a portion of the underside of the surf craft without the one or more illuminated portions is equal to, or greater than, 85% Michelson contrast.

45. The surf craft of claim 34, wherein the one or more illuminated portions are configured to provide illumination continuously.

46. The surf craft of claim 34, wherein the one or more illuminated portions comprise a shield that is configured to reduce and/or block electrical fields emanating away from the surf craft.

47. The surf craft of claim 34, wherein the one or more illuminated portions comprise one or more lights.

48. The surf craft of claims 47, wherein the one or more lights are uniformly distributed.

49. The surf craft of claim 48, wherein a density of uniform distribution is between 60 and 240 light units per linear meter.

50. The surf craft of claim 34, wherein the one or more illuminated portions provide white light.

51. The surf craft of claim 34, wherein the one or more illuminated portions substantially mimic or exceed the brightness, at a wavelength or a combination of wavelengths, of a downwelling light of a surrounding area of ocean.

52. The surf craft of claim 34, wherein the one or more illuminated portions have a radiance, at a wavelength or a combination of wavelengths, that is brighter than 2×10⁻³ W cm⁻² sr⁻¹.

53. A system for reducing interaction of sharks with a surf craft, the system comprising arranging one or more lights on at least a portion of downward facing surfaces of the surf craft, the one or lights being arranged such that the surf craft is counter-illuminated.
